(19) United States
(12) Patent Application Publication
(10) Pub. No.: US 2013/0260790 A1
(43) Pub. Date: Oct. 3, 2013

(54) METHOD AND SYSTEM FOR PROVIDING LOCATION IDENTIFICATION

(71) Applicants: Chen ITZHAKI, Herzeliya (IL); Ofer TALMOR, Atlit (IL)

(72) Inventors: Chen ITZHAKI, Herzeliya (IL); Ofer TALMOR, Atlit (IL)

(73) Assignee: STOREWARDS LTD., Herzeliya (IL)

(21) Appl. No.: 13/854,338

(22) Filed: Apr. 1, 2013

Related U.S. Application Data
(60) Provisional application No. 61/618,874, filed on Apr. 2, 2012.

(51) Int. Cl. H04W 4/02

(52) U.S. Cl. CPC H04W 4/02
USPC 455/456.1

(57) ABSTRACT

A method and system for providing location identification, including a server and a corresponding database storing data representing the deployment of network transmitters in a specific area. The system configured to measure, over different selected locations in the specific area, the signal strength as received from one or more network transmitters deployed in the area; map a network signals power scheme for each specific area based on the measured signal strengths; store the mapped power scheme(s) in the database; receive measurements and/or calculations from devices in a previously mapped specific area; compare the local calculated/measured power scheme with one or more power schemes stored in the database; and, upon finding a power scheme that essentially corresponds to the location of the local calculated power scheme, determine the current location of the corresponding device.

### CROSS REFERENCE TO RELATED APPLICATIONS

This patent application claims priority to U.S. Provisional Patent Application No. 61/618,874, filed Apr. 2, 2012 entitled “A Method and System for Providing Location Identification.”

### FIELD OF THE DISCLOSURE

The present disclosure relates to the field of location identification. More particularly, the disclosure relates to a method and system for identifying the location of a network enabled mobile device indoors. A common usage would be to identify the location of a user equipped with network enabled phone/tablet indoors (e.g., in a mall or within a store in a shopping center).

### BACKGROUND

One of the hottest trends in the mobile phone market and mobile phone applications is Location Based Services (LBS). LBS is an information or entertainment service, accessible with mobile devices through the mobile network and utilizing the ability to make use of the geographical position of the mobile device.

LBS can be used in a variety of contexts, such as health, indoor object search, entertainment, work, personal life, etc. LBS include services to identify a location of a person or object, such as discovering the nearest banking cash machine or the whereabouts of a friend or employee. LBS include parcel tracking and vehicle tracking services. LBS can include mobile commerce when taking the form of coupons or advertising directed at customers based on their current location. They include personalized weather services and even location-based games. They are an example of telecommunication convergence.

The precondition to use location based services is to be able to identify the location of the user, mostly via his mobile phone. There are several common methods to achieve that. The most common technology used by most of the mobile phones today is Global Positioning System (GPS). This technology is widely used since its cheapness (as for the hardware, and free usage), coverage, accuracy (usually few dozens meters) and simplicity. No installation is needed, and the coverage is unlimited. However, indoors, as inside buildings, in urban malls or in tunnels, the GPS reception is weak or does not exist.

Another common method is the identification using Cellular Base Stations. In addition to GPS, few vendors provide location identification using a triangular computation based on the cellular base stations. In urban locations where the cellular coverage is relatively high, it can be very accurate and simple. In the past it used to require an involvement of the cellular provider (who usually owns the cellular based stations), but today there are several 3rd party solutions that provides this service. This solution is usually effective in urban areas, but may not be accurate inside buildings, or in remote areas. Accordingly, exemplary embodiments may provide the infrastructure which can be used to identify the location of a network enabled device indoors.

Other objects and advantages will become apparent as the description proceeds.

### SUMMARY OF THE DISCLOSURE

The present disclosure relates to a method for providing location identification, comprising the steps of: a) providing a server and a corresponding reference database for storing data representing the deployment of network transmitters in a specific area; b) measuring, over different selected locations in said specific area, the signal strength as received from one or more network transmitters deployed in said area; c) mapping a network signals power scheme for each specific area, wherein each power scheme represents the measured signals strength as received from the network transmitters deployed in each specific area; d) storing each of said mapped power scheme in the reference database; e) while being presence in a specific location that was previously mapped, allowing network enabled devices to measure and/or calculate in real-time the local power scheme at said specific area and to further submit it to said server; and f) comparing said local calculated/measured power scheme with one or more power scheme stored in said database, and upon finding a power scheme that essentially corresponds to the location of said local calculated power scheme—determining the current location of the corresponding user device (i.e., of the network enabled device).

According to an exemplary embodiment, the method further comprises continuously updating the stored power scheme in the reference database according to one or more power scheme submitted by network enabled devices.

Exemplary embodiments may further relate to a system for providing location identification, which may comprise:
a. a server and a corresponding reference database for storing data representing the deployment of network transmitters in a specific area;
b. one or more network enabled devices adapted for measuring, over different selected locations in said specific area, the signal strength as received from one or more network transmitters deployed in said area; and
c. a mapping module for mapping a network signals power scheme for each specific area, wherein each power scheme represents the measured signals strength as received from the network transmitters deployed in each specific area.

According to an exemplary embodiment, the network enable devices or other mobile device (e.g., a smart-phone) may be adapted to measure and/or calculate in real-time the local power scheme at a specific area and may further submit it to the server.

According to an exemplary embodiment, the server may further comprise a location determination module for determining the current location of a network enabled device or other mobile device, by comparing a local calculated/measured power scheme with one or more power schemes stored in a database.

### BRIEF DESCRIPTION OF THE DRAWINGS

In the drawings:

FIG. 1 illustrates a Wi-Fi Location Identification (WLI) system integrated indoors (in this example, a shopping mall), according to an exemplary embodiment; and

FIG. 2 is a flowchart illustrating an algorithm for providing Wi-Fi location identification, according to an exemplary embodiment;

FIG. 3 is a flowchart illustrating an algorithm for providing Wi-Fi location identification, according to an exemplary embodiment; and

FIG. 4 is a flowchart illustrating an algorithm for providing Wi-Fi location identification, according to an exemplary embodiment.

### DETAILED DESCRIPTION

The method and system relies on characterizing a given area by the signal strength of wireless network transmitters (e.g., Wi-Fi transmitters, Wireless Access Points or other wireless network devices) that cover the given area (i.e., herein a power scheme or a power profile). The Figures and the following description relate to preferred embodiments by way of illustration only. It should be noted that from the following discussion, alternative embodiments of the structures and methods disclosed herein will be readily recognized as viable alternatives that may be employed without departing from the principles of the disclosure.

Reference will now be made to several embodiments, examples of which are illustrated in the accompanying figures. Wherever practicable similar or like reference numbers may be used in the figures and may indicate similar or like functionality. The figures depict exemplary embodiments for purposes of illustration only. One skilled in the art will readily recognize from the following description that alternative embodiments of the structures and methods illustrated herein may be employed without departing from the principles described herein.

Unless otherwise indicated, the functions described herein may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

Similarly, while certain examples may refer to a network enabled mobile device, other computer or electronic systems can be used as well, such as, without limitation, a tablet PC, a network-enabled personal digital assistant (PDA), a networked entertainment device, a smart phone (e.g., with an operating system and on which a user can install applications) and so on.

The term “area” refers herein to any location that could be a mall, shopping center, airport or one or more buildings forming a complex of “points of interest” (e.g., shops within a mall) that are physically located in the same place.

For example, an area may be defined by the following parameters:
Area name (for example—“7 stars” mall);
Area location—a range of coordinates representing the location (for example—between 32:09:57:6N and 32:09:49:75N and between 34:49:22:08E to 34:49:32:0E), or any other definition of physical area; and
Area signals—the list of network signals that have been found in the area (e.g., this may include all signals, including “uncertain” signals as will be described hereinafter).

The term “signal” refers herein to the radio waves transmitted by an active wireless network router, transmitter, Wireless Access Point (WAP) or other network device that is located in a static place.

For the sake of simplicity, a system for providing location identification based on the infrastructure of a typical Wireless Local Area Network (WLAN) is described. However, other infrastructures may be used. The location identification may be based on the existence of Wi-Fi signals within a specific area (e.g., a shopping mall) as transmitted from plurality of wireless network devices (e.g., Wi-Fi transmitters, WAPs, and the like). However, as will be appreciated by the skilled person, other wireless communication technologies may be used instead of (or in addition to) the Wi-Fi system, such as an interoperable implementations of the IEEE 802.16 family of wireless-networks standards (i.e., known as WiMAX).

Wi-Fi Technology

The vast majority of the deployed network enabled devices (e.g., Smart-phones or other mobile devices), as well as some of the featured-phones that support internet browsing support Wi-Fi networks identification and connection (also known as IEEE 802.11). During the connection process, the network enabled devices may regularly transmit the following information:
Information about the sub-protocol they using (for example—IEEE 802.11n);
Information about the identification of the device (i.e., its unique ID). Usually it's the MAC address of the device, but it may be any other unique identifier assigned to network interfaces for communications on the physical network segment.
Information about connection security level and (optionally) the device IP addresses; and
The Wi-Fi signal strength may then be calculated by the mobile device.

Usually, the signal's strength depends on the network enabled device, the device's strength, the protocol it is using and its type, and the distance between the transmitter device and receiver device. The closer the receiving mobile phone is to the transmitter device, the stronger the signal strength becomes.

Infrastructure

The following example describes a WLAN-based positioning system based on Wi-Fi signals using an example of a shopping mall provided with plurality of Wi-Fi transmitters deployed in different locations in that shopping mall.

Each point inside the area of the shopping mall may be identified with a unique set of signals and their strengths. According to an exemplary embodiment, by gathering all these signals, the system may be able to determine the exact location of a user (for example, by his/her smart phone or other network enabled portable device). According to preliminary tests taken in several shopping malls, the average accuracy in these shopping malls was within a few meters, depending, of course, on the density of the existing wireless network devices.

The network enabled devices may not be connecting or browsing through these Wi-Fi transmitters. Moreover, the method suggested by the exemplary embodiments may not load or even require any attention from these devices. Only the signal name, ID (e.g., MAC address) and strength may be collected by listening to those signals regularly. In addition, the system may not care about the security level of these Wi-Fi transmitters as it may not require connecting to those transmitters. Any Wi-Fi transmitter may be used by the system, as long as the transmitter is visible.

According to an exemplary embodiment, the system may consist of two main components:
An initialization application that defines the wireless network signals power scheme for selected location points in the shopping mall, and coordinates between the visual representation of the shopping mall (i.e., the mall's map) and the location of each Wi-Fi transmitter respectively; and
Ongoing usage:
   Application Programming Interface (API) for determining locations based on the defined power scheme; This API may be used by the system itself, or provided as a service for other external systems.
   Automatic and ongoing updates to the area's (in this example, the mall) power scheme.

Using the API to determine the location may comprise two main steps:
Receiving any location information that may be collected—GPS, cell, Wi-Fi, etc. and:
   Returning the location of the user's mobile device;
   Using the signals information: updating the signals map by adding new signals, deleting inoperative ones, and updating signals information;
   Using the exact location of the user's mobile device, e.g., for providing offers that may suit to the user.

Certain/Uncertain Signals

Some of the signals may not be relied on when calculating the location. There may be several reasons for that, for example:
Several signals with one logical name (only if the MAC address of a signal cannot be identified);
A signal that is spread in a large area;
A signal that may be portable or temporary; and
A signal that is not constant or not reliable.

With respect to the system, these un-relied signals may be used for area identification, for example, but not for location identification within the area. These signals may be called uncertain signals. All other signals that may be used for calculating the location may be called certain signals.

According to an exemplary embodiment, the system may use a three-level signals hierarchy:
“Brand new” is a signal that had been transmitted to the system's server, but does not exist within the server's database. This signal will be added to the database, and will become a “known-new” signal;
A “known-new” signal is a signal that already exists in the database, but has not proved itself to be relied on. In this stage, the status of the signal is in the same level as an uncertain signal (when referring to area identification); and
A “Verified signal” is a signal the system determines it can rely on (i.e., a certain signal). A verified signal may be determined according to the number of times it had been found by the user's network enabled device, and/or the frequency that the server has been notified about the signal (e.g., after 5 consequently identification of a signal, it may be verified and added as a Verified Signal). The reason for this extra caution may be to make sure the signal is not temporary, and had not been identified by mistake.

The output of the analysis of a set of Wi-Fi signals received from a user's mobile device may be the user's location within an “area” and the output may be one of the following with respect to “points of interest”:
In or very close to a specific point (e.g., <point 1>);
In the area of a specific point (e.g., <point 1>); and
Between two specific points (e.g., between <point 1>and <point 2>)

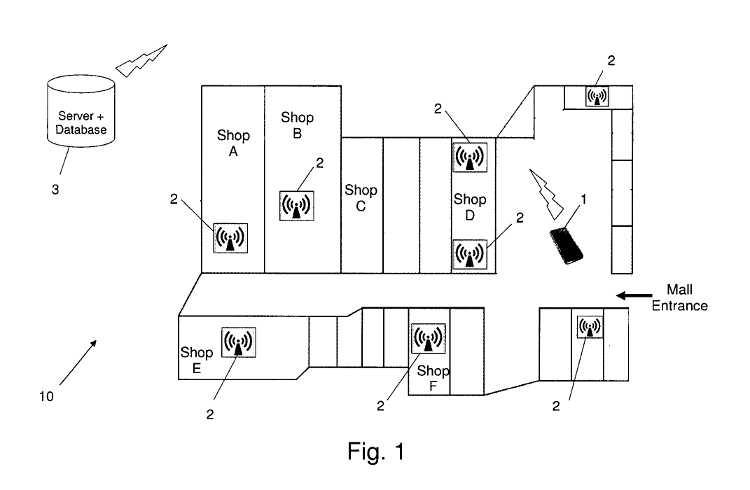

FIG. 1 schematically illustrates a Wi-Fi Location Identification (WLI) system 10 integrated in a shopping mall, according to an exemplary embodiment. The WLI system 10 may include a client application that resides on a network enabled user device 1, such as a mobile phone (e.g., a smartphone). Throughout a particular target geographical area, there may be several wireless transmitters 2 that transmit information using common channel signals. The user device 1 may monitor these transmissions. Each transmitter 2 may contain a unique hardware identifier such as a MAC address. The client application may receive transmissions from the transmitters in its range and calculates the geographic location of the user device 1 using the characteristics of the radio signals. Those characteristics may include the MAC addresses, the unique identifiers of the transmitter 2 and the signal strength as measured at the user device 1.

The WLI system 10 may compare the observed transmitters 2 with those stored in a reference database 3. According to exemplary, this reference database 3 may resids in a remote server. Alternatively, the reference database 3 or subset of the reference database 3 may reside in the user device 1. The reference database 3 may contain the calculated geographic locations and power profiles of all transmitters 2 the WLI system 10 has previously collected (as will be described in further details hereinafter). A power profile at each specific location may be generated from a collection of measurements of the signal strength at various locations. Using these known locations or power profiles, the WLI system 10 (either by a remote application that resides in the system's server or by the client application) may calculate the position of the user device 1 in an absolute geographic coordinates format (e.g., in the form of latitude and longitude). These readings may then be fed to location-based applications such as messages or an advertising service, friend finders, etc.

The raw WLAN measurements from a transmitter 2 may be intended to mean the received signal strength. References to data may be intended to mean the MAC address, one or more record(s) of it, one or more power profile(s), and other attributes based on previous measurements of that transmitter as described with further details hereinafter.

The WLI system 10 may be used indoor or outdoor. In FIG. 1 the WLI system 10 is used in a mall with a plurality of shops (as schematically indicated in the figure by Shop A to Shop F). The only requirement is presence of Wi-Fi transmitters 2 in the vicinity of the user. The WLI system 10 may be leveraged using existing off-the-shelf WLAN devices without any modification other than to employ logic to estimate position. For example, the WLAN devices may be simple and pre-configured Wi-Fi transmitters with the following attributes:
These devices may not be connected to the internet (but if needed, could);
These devices may be connected to a power source (e.g., an electricity outlet or a battery); and
These devices may be preconfigured with a Media Access Control (MAC) address.

In outdoor locations or in areas where it is also possible to use GPS receivers, the WLI system may be used together with GPS on a consumer's phone. This combination may be used to provide more accurate location identification.

Identifying and Determining the Location

According to an exemplary embodiment, in order to determine the location of a mobile device when the device is located indoors (i.e., inside the mall), the device may use a mobile application (or alternatively, a service library inside another application), that is installed on the mobile device. This application may detect the Wi-Fi signals in the phone's environment and send the detected signal data to a server. The detected signal data may include the names of these Wi-Fi signals and their respective signal level strengths.

In order to enable identifying and determining the location of a network enabled device in a specific mall or other indoor area, the system may map various signals in a specific area (this refers herein to the system initialization stage, as described hereinafter with further details). Accordingly, since the map of the specific area (e.g., mall), including the locations and signals strengths of the Wi-Fi transmitters, may be stored in the server, the server may calculate the location of a smart phone or any other network enabled device.

An initialization stage may first be used to map the values of the signal strength throughout an area in which a network enabled devices is intended to be tracked. After the initialization stage the values of the transmitters signal strengths may be used to find the most probable device location. In one implementation, the method may compare a measured wireless signal strength to a table of wireless signal strengths and known locations (i.e., “points of interest”), find a table entry with the closest signal strength to the measured signal strength, and determine a location by reference to the found table entry.

The method may rely on learning techniques, which may involve the collection of labeled network samples. The initialization stage may include physically visiting the “area” in order to record a series of network samples for training the system as described with further details herein below.

System Initialization Stage

The system initialization stage may require a recording of the Wi-Fi signals indoors “area” in different location, by using a recording-application. When using the system within a mall, for example, this recording-application may enable the system to match a map of an indoor area, such as a mall, a map of current Wi-Fi signals within the indoor area, such as the mall.

In this stage, the system may use the following components:
A list of locations (“points of interest”) inside the indoor location to be recorded. In a mall for example, these locations (points) might be locations inside a store or public locations in the mall. Theoretically, the “points of interest” are very close to each other and they form a continuous function. Practically, the “points of interest” are forming a discrete function where there is a trade-off between the distance between consecutive “point of interest” and system's accuracy.
A network enabled device with the initialization application installed on.
A map of the mall is optional.

This process may include three main steps:
The first stage may be to gather the points of interest inside the mall. These points may be entered with or without a context of a map.
The initialization application may ask a user to go to each point gathered, and approve certain data while standing in the point of interest location. The initialization application may then sample the Wi-Fi signals that are received at this point. This sample process may be performed few times.
After sampling all the points, the system may analyze each Wi-Fi signal, calculate the point's location inside the mall, and insert the information about the signal (e.g., its MAC address), the signal strength in the different locations (points) indoors, and a calculated location into the database.

As aforementioned, the system may require a definition of the area's map, including stores location and Wi-Fi reception. This step may be performed using a designated application. This application may be based on a network enabled device (e.g., a smart-phone, a laptop, etc.) and may collect Wi-Fi signal samples in order to create a Wi-Fi signal map.

The recording application may be based on a detection algorithm which may be executed once for each area. This detection algorithm may be responsible for the initial detection of the Wi-Fi signals in that area. The detection algorithm may include the following steps (as will be described in further details hereinafter):
Map preparation (points definition);
Recording; and
Data analysis.

This designated application may provide a detailed mapping between the mall and the Wi-Fi signals. This mapping may actually include a dictionary that defines the set of signals and their strengths for each point in the mall.

According to some embodiments, the definition of the map may be a set of points of interest in a mall, with links between any adjacent points. According to other embodiments, the definition of the map may be extended to a real map with coordination, on which the different points may be defined.

Points Definition

The definition of the points may be a way to sketch a map of the indoor area, such as a mall. In this step, a set of “points of interest” may be defined, as well as the adjacency between these points. For example, the definition of different points (or the considerations which points to define) may be based on one or more criteria such as:
Business aspects—stores or departments within stores or locations that may interest the system's owner from the business point of view;
Points that are on the main path of potential users, like the mall's avenues;
In case of more than one floor, it may be important to define the same points map for each floor separately. For example, when defining a specific point near a specific store on the first floor, it is recommended to define another point on the same location on the second floor. This may help the system identify the accurate location of the customer;
The gap between a pair of points, where the gap may be defined as not greater than few meters. In bigger gaps, an algorithm may output less accurate results;
In order to ease the definition process and to increase the system's accuracy, a point may include an accurate location description, such as “Cashier 2 in GAP's women department,” “Left corner of the T-Shirts shelf in GAP's women department,” or “GAP's main entrance.” Alternatively, location descriptions may include, “Inside GAP,” “GAP's women department,” or even “T-Shirts shelf in the women department in GAP.”

The following Table 1 demonstrates an example of point definition (taken at the “Azrieli” mall in Tel-Aviv):

TABLE 1

| | | Adjacent |
|---|---|---|
| Point | Position | points |
| 1 | Super-pharm entrance | 2, 6, 7 |
| 2 | Discount bank ATM (near the north mall's | 3, 1 |
| | entrance) | |
| 3 | ALM entrance | 4, 2 |
| 4 | ML men entrance | 5, 3 |
| 5 | Castro men entrance | 7, 4 |
| 6 | Super-pharm pharmacy, cashier 2 | 1 |
| 7 | At the bottom of the escalator from | 5, 1 |
| | 1st to 2nd floor on the 1st floor | |

For example, the output of this step may be a file containing the data shown in Table 1 above.

Recording

This application may receive a list of points in an indoor area, such as a mall, and output a list of signals (and signals' strengths) linked to at least one point. In order to create such list, a manual definition (using the initialization application) may be required.

The user that records the track may open a recording application, and use a list of points as defined, for example in Table 1, to perform the recording step. For example, the application may perform the following tasks:
For each defined point:
   Show the position of the point (e.g. main entrance to Gap);
   Wait until the user reaches this point;
   As the user approves his or her location of this point (e.g., by clicking on an “I am here” button of the application UI), performing the steps of:
      Searching for Wi-Fi signals;
      Saving the signal information (e.g., SSID, MAC address) and strength;
      Repeating the searching and/or saving step(s) several times;
      Saving all samples;
      Including GPS information (if available).
   (Optional) Track(on a continuous basis) the Wi-Fi signals in order to get the signals strength “between points”; and
   Load the entire list to the system's database.

Data Analysis

According to an exemplary embodiment, the output of the recording application may include a raw list of points, with a set of corresponding Wi-Fi signals for each point. Each point may have few sets of Wi-Fi signals from several repeated samples. Some of those signals may not be useful for location identification due to reasons such as:
Weak signal strength;
Signals that cover a wide area with the same strength;
Signals that are received in one location only;
Signals that are inconsistent; and
Signals with a dynamic coverage area.

The next step may be to review and analyze the recording results, filter the good signals, and reverse the dictionary so that the signal is turned into the key and the point is the corresponding value. An implementation example of how to take district recordings samples and analyze them may follow. Other methods such as approximation functions may apply. This example of implementation may involve the following steps:
Taking signals that are found and inserting them into a database (DB). The DB may include two main tables—signals table (name, MAC address, type) and samples table (location, signal, strength);
For each signal
   Getting a list of all locations where the signal is accepted and sorting the locations by strength;
   In case there are enough (set parameter) samples of the signal, and the strength of the signals is high enough:
      Checking whether the signal samples “make sense” with respect to their location, e.g., the location of the Wi-Fi transmitter can be deduced from the signal's samples. This conclusion can be made in case the signals are not scattered and the signal locations are close;
      If the signal samples doesn't “makes sense”:.
         Marking the signal as uncertain signal;
      Else (the signal is good)
         Estimating/Determining where the source of the signal is located, by a weighted geographical center (Centroid) of the top signals. A weighted geographical center of the top signals may be a geographical weighted average of the strongest signals in order to analyze the signal source. For example, looking at a network transmitter A that had been detected by the detection application in points 1, 2, 3, and 4, with different strengths in each point. The location of the network transmitter A may be calculated according to the weighted average of signals 1, 2, 3 and 4;
         Setting the following parameters:
         Signal source;
         Signal strength (how far from the source is it available?);
         Signal reception in other floors (if exist);
         Going over the signal's samples, and for each sample of the signal, saving the following:
         The signal SSID and MAC address; and
         Its calculated location.

System Self-Learning

According to an exemplary embodiment, the system may further comprise a self-learning module. Such a self-learning module may be required when the Wi-Fi transmitters' network is dynamic as transmitters are added, dropped, and/or changed over time. Therefore, when determining the location of a Wi-Fi enabled mobile device, the system may receive some new signals, updated signals, and/or missing signals. By analyzing the signals, a user's mobile device is sending to the system's server, the system may perform two main tasks:
Identifying the user's location within the indoor area, such as a mall; and
Automatically updating the data and logic with the new data just collected.

This self-learning module may enable the system to automatically add new signals, delete signals that are not used anymore, and update signals changes. The above will be better understood through the following illustrative and non-limitative example of a self learning system.

### EXAMPLE 2

Let's take a specific point. For example, the current signals map for this specific point is shown in the following table 2:

TABLE 2

| | Signal strength in this point |
|---|---|
| Signal ID | (in a scale of 1-5) |
| 1 | 5 |
| 2 | 5 |
| 3 | 2 |
| 4 | 2 |
| 5 | 1 |
| 6 | 1 |

The following table 3 shows the received signals for this specific point:

TABLE 3

| | Known Signal strength in | Current sample |
|---|---|---|
| Signal ID | this point (in a scale of 1-5) | signal strength |
| 1 | 5 | 5 |
| 2 | 5 | 5 |
| 3 | 2 | — |
| 4 | 2 | 5 |
| 5 | 1 | 1 |
| 6 | 1 | — |
| 7 | — | 3 |

After analyzing the location according to the signals strength, the following issues may have been raised:
Signal 7 is also being received in this location. This signal may be added to the database as a new signal. Later on, after getting more receives of this signal, it may be verified and added to the database as a trusted signal.
Signal 4 is changed. Any change of the signal strengths may be recorded. In case of a consistent signals change, the signal strength value may be updated in the database. This may be a result of a change of the location or the device of the Wi-Fi transmitter, for example.
Signal number 3 and 6 have not been sampled. It may imply that the signals are down temporarily or permanently. Alternatively, it may have been too weak, signal 6 that may already known to be weak at this point, might have been too weak in this sample, and might not be recorded. This information may be stored in the database, and in case that this sample will not be recorded for long time, it will be deleted.

This may be done by letting the user's mobile device report the radio condition it experiences (i.e., regarding the transmitted signals) to the system's server that determines the device location. Of course, depending of the settings, the user may reject or object to this approach, for privacy reasons.

Algorithms

The following are examples for WLI algorithms that may be related to the user identification:
“Area identification” module—may be executed once the user opens the application in order to determine its general location (e.g., in which mall am I?); and
“Track me” module—may be executed regularly when the application is turned on and after running the “Area identification” module.

“Area Identification” Module

This algorithm may be used to locate the general location of the user once he or she opens or re-enters the application. This means that the system may attempt to understand in which area (mall, shopping center or other institute) the user is currently located. This task may not always be simple. In case of GPS signal or any triangular cells signal, it may be easy, but the system may have to be able to determine the location of the user even without GPS, and without relying on the cell towers triangular identification.

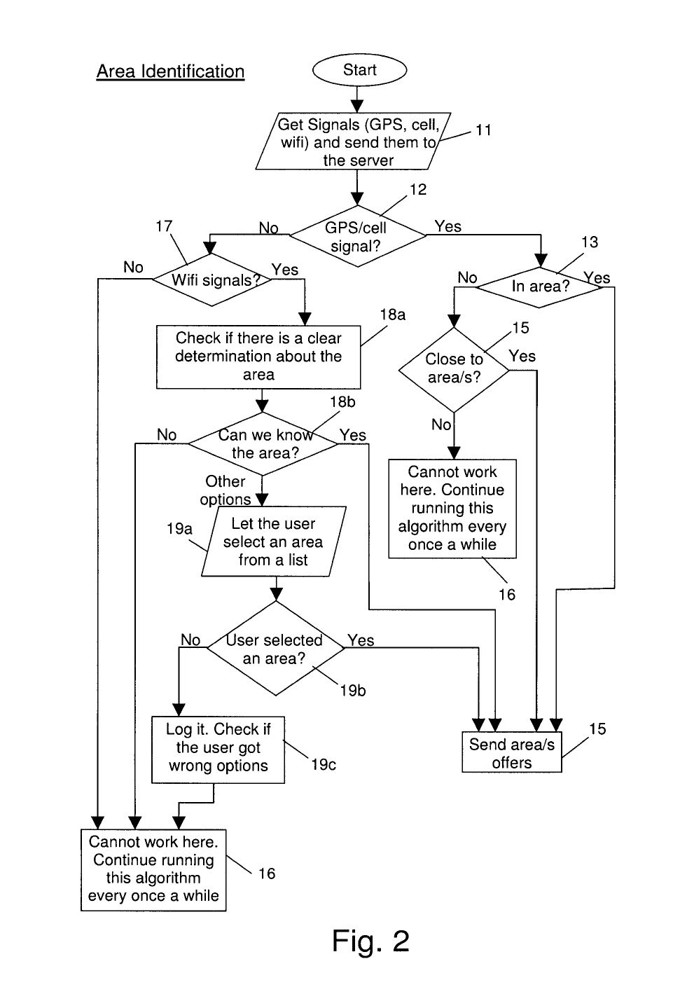

Referring now to FIG. 2, a flow chart of the “Area identification” module is illustrated in accordance with an exemplary embodiment. The “Area identification” module begins after opening the application.

In this example, the “Area identification” module may consider the following:
1. GPS/cell signal—cellular signal will be fetched by any suitable API module, such as the Google Location API or similar API;
2. In area—the meaning is whether the user is within the coordinates that define a specific area;
3. Close to area—parametric and depending on the area itself. Each area can have an area around it that could consider “around the area”. For example, malls in less rural places and bigger malls may have a bigger “close to area” area (e.g., in form of a rectangular or other; and
4. Clear determination about the area—the system may analyze a set of signals received from a user's mobile device and attempt to understand whether those signals are unique to an area. Sometimes the system may be able to know the area for sure. In other cases, the output may be a list of possible areas, and sometimes may not be able to determine a user's location. The order between the areas may be suggested by the algorithm, but may also be depended on the user's visits history.

According to an exemplary embodiment, the area identification may be obtained by the Wi-Fi signals only. In a related embodiment, the area identification may be obtained by other methods.

For example, the “area identification” process may involve the following steps:
At first, getting signals (GPS, cell, Wi-Fi) from a user network enabled device (e.g., a smartphone) and sending them (via the user's device) to the systems' server (as indicated by numeral 11 in FIG. 2);
At the next step (12), checking whether there is a GPS or cellular signal:
   If yes, checking whether the location of the user's device is “in area” (13) or close to the area (14) (i.e., within the coordinates that define a specific area);
      if yes, sending to the user's device location based information (15), such as commercial offers related to nearby shops;
      if no, continue running this algorithm every once a while (16) for checking whether the location of the user's device becomes “in area” (13);
   if no, checking whether Wi-Fi signals exists (17);
      if no, continue running this algorithm on a predefined schedule (16) until the location of the user's device becomes “in area” (13);
      if yes, checking (18a, 18b) if there is a clear determination about the area. If yes, sending to the user's device location based information (15), if no, allowing the user to manually select an area (19a), e.g., from a given list with optional areas as provided by the system, if the user selected an area (19b), sending to the user's device location based information (15), if not, checking whether the user got wrong options to select from (19c) and continue running this algorithm on a predefined schedule (16) until the location of the user's device becomes “in area” (13).

The following example (Table 4) demonstrates three cases and expected results when running the algorithm over a set of received signals 1, 2, and 3 from a Wi-Fi enabled mobile phone:

TABLE 4

| Area 1 | Area 2 | Area 3 | Result (ordered) |
|---|---|---|---|
| 1 | 5 | 5 | Area 1 |
| 2 | 6 | 9 | |
| 4 | 7 | 10 | |
| 6 | 8 | 11 | |
| 1 | 1 | 9 | Area 1 |
| 2 | 5 | 10 | Area 2 |
| 4 | 6 | 11 | |
| 6 | 7 | 12 | |
| 5 | 7 | 9 | Cannot know |
| 6 | 8 | 10 | |

In case more than one area is possible, the user may get a list of areas in order to select the area where the user is. The areas may be sorted a suggested by the algorithm and/or by the user's history. In the instance of a wrong location detection, (i.e., the user had not selected any area), the system may log this issue for further analysis in order to improve the algorithm robustness.

“Track Me” Module

This algorithm may be used to identify the user location inside the area, and track the user's movement. The algorithm may be executed on a predefined schedule (e.g., every few seconds, minutes, etc.) in order to update the offers list. According to some embodiments, the system responds to each user's location separately, and may not refer to a user's movement. According to other embodiments, the system may analyze the user's movements as well.

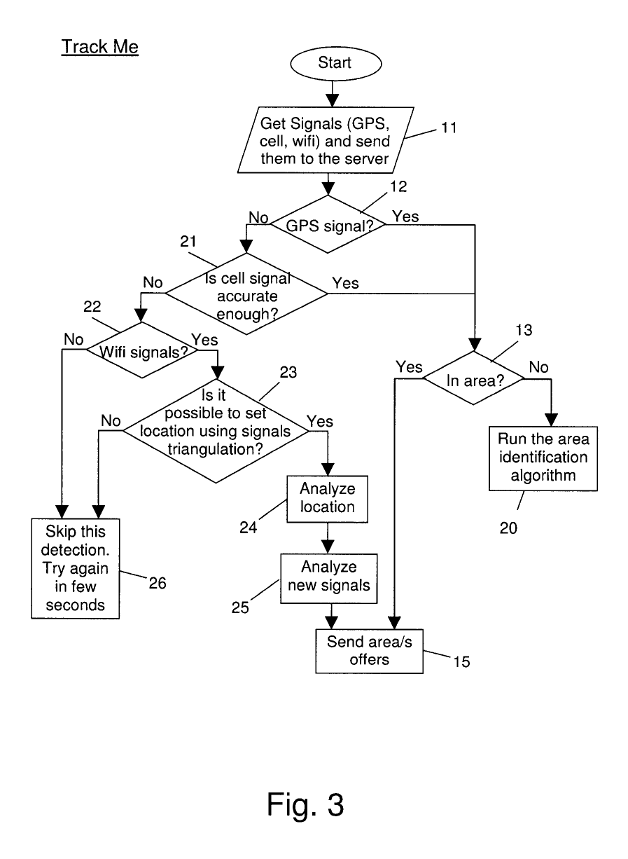

Referring now to FIG. 3, a flow chart of the “Track Me” module is illustrated in accordance with an exemplary embodiment. In this example, the “Track me” module may consider the following:
1. One of the parameters given by a vendor, such as Google (or by other vendors), about the cells signals may be a location determination accuracy. One of the configurable system's parameter may be the minimum accepted accuracy level. If the return results would be above this minimum value, the system may be able to calculate the location according to the cell signals only; and
2. If there's no way to calculate the location, the system may ask the user's network enabled device again, after a relatively short period, to provide another set of signals in order to run the calculation again. After several false trials, the period between requests may be set to the default again in order not to overload the user's network enabled device.

According to an exemplary embodiment, the “track me” module may be obtained by the Wi-Fi signals only. However, in a related embodiment, the area identification may be obtained by other methods.

For example, the “Track Me” process may involve the following steps:
At first, getting signals (GPS, cell, Wi-Fi) from a user network enabled device (e.g., a smartphone) and sending them (via the user's device) to the systems' server (as indicated by numeral 11 in FIG. 3);
At the next step (12), checking whether there is a GPS or cellular signal:
   If yes, checking whether the location of the user's device is “in area” (13);
      if yes, sending to the user's device location based information (15);
      if no, executing the area identification algorithm (20);
   If no, checking whether the cellular signal is accurate enough (21);
      if yes, repeating the “in area” step (13);
      if no, checking whether Wi-Fi signals exists (22). If Wi-Fi signals exists, checking whether it possible to set location using signals triangulation (23) and if it possible analyzing the location (24) and the new signals (25). If Wi-Fi does not exist or it is not possible set location using signals triangulation than skipping the location detection (26).

The WLI system may include several rules that determine whether the system can determine a user's location using the given signals. For example, insufficient or limited number of samples, or a combination of samples that contradict each other (for example, in case of receiving two samples that are considered to come from two different places inside the mall), may confuse the system and require an additional sample, or may return an uncertain or uncertified result. Accordingly, the system may include a set of rules that defines the minimal number of signals that may be required to determine the location, the minimal strength of a signal in order to take itself into account, and/or the number of resamples that may be required to determine the location. As an example, sometimes the results of an analysis may be given based on a single signal, and in other cases few signals will not be enough.

Analyze Location

Take the certain signals, draw each of the certain signals on a map of the area, and determine the intersection between all those areas. The center of this calculated area may be the location.

Analyze New Signals

One of the most important features of the WLI system 10 may be to learn and update the signals list. The list can be updated in several different ways, such as by:
Adding new signals to the Database (DB) (phase 1);
Deleting signals that are not used anymore (phase 2); and
Updating signals' area and strength (phase 2).

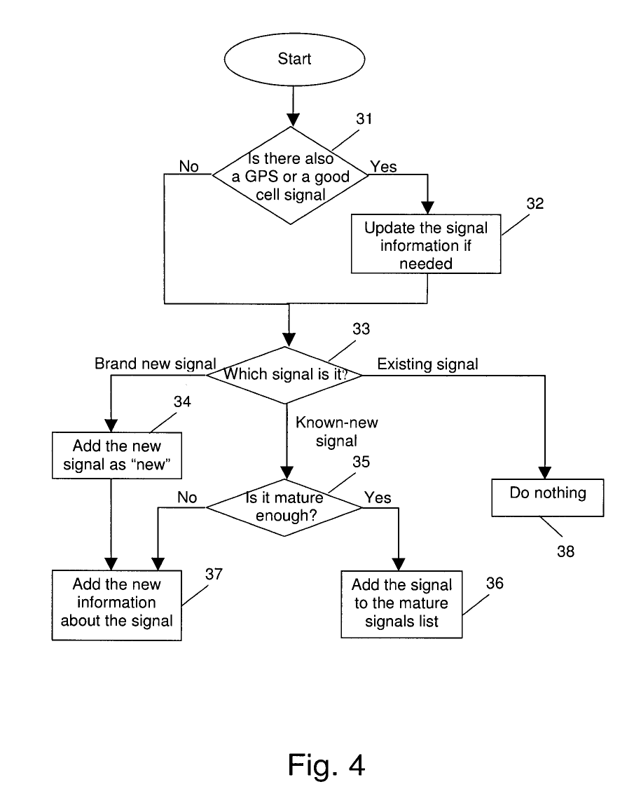

The flow chart shown in FIG. 4 demonstrates the algorithm implementation in phase 1. Any detection of a signal may be written to the DB, usually for statistics. This information may be used for delete/update signal in phase 2. For example, if the signal seems to be stable (e.g., it had been found several times, regularly, and with stable signal), the signal may be “mature.”

The process of adding signals to the DB may involve the following steps:
For each detected signal, checking (31) whether a GPS signal or a good quality cellular signal also exists. If exists, updating the signal information if needed (32). If not exists, checking which type of signal it is (33) (i.e., whether it an existing signal, brand new signal or a known-new signal);
For an existing signal, the system may do nothing (38);
For a brand new signal, adding it to the DB as a new signal (34) and adding the new information about that signal (37);
For a known-new signal, checking whether it is mature enough (35). If yes, add the signal to the mature signals list (36). If no, adding the new information about that signal (37).

As described hereinbefore the Wi-Fi enabled devices may not be required to connect or browse through the Wi-Fi transmitters. Moreover, the method suggested by the present invention may not load or even require any attention from these devices. In addition, the system may not care about the security level of these Wi-Fi transmitters as it may not require connecting to those transmitters. Any Wi-Fi transmitter may be used by the system, as long as the system is visible.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

All the above description and examples have been given for the purpose of illustration and are not intended to limit the embodiments in any way. Many different mechanisms, methods of analysis, electronic and logical elements can be employed, all without exceeding the scope of the invention.

1. A method for providing location identification, comprising the steps of:
a. providing a server and a corresponding reference database for storing data representing the deployment of network transmitters in a specific area;
b. measuring, over different selected locations in said specific area, the signal strength as received from at least one network transmitters deployed in said area;
c. mapping a network signals power scheme for each specific area, wherein each power scheme represents the measured signals strength as received from the at least one network transmitters deployed in each specific area;
d. storing each of said mapped power scheme in the reference database;
e. while being presence in a specific area that was previously mapped, allowing network enabled devices to measure and/or calculate in real-time the local power scheme at said specific area and to further submit it to said server; and
f. comparing said local calculated/measured power scheme with at least one power schemes stored in said database, and upon finding a power scheme that corresponds to the location of said local calculated power scheme, determining the current location of the corresponding network enabled device.

2. A method according to claim 1, further comprising continuously updating the stored power scheme in the reference database according to at least one power scheme submitted by the network enabled devices.

3. A system for providing location identification, comprising:
a. a server and a corresponding reference database for storing data representing the deployment of network transmitters in a specific area;
b. at least one network enabled device adapted for measuring, over different selected locations in said specific area, the signal strength as received from one or more network transmitters deployed in said area; and
c. a mapping module for mapping a network signals power scheme for each specific area, wherein each power scheme represents the measured signals strength as received from the network transmitters deployed in each specific area.

4. A system according to claim 3, in which the at least one network enable device or other mobile device is adapted to measure and/or calculate in real-time the local power scheme at the specific area and to further submit it to the server.

5. A system according to claim 4, in which the server further comprises a location determination module for determining the current location of the network enabled device or the other mobile device, by comparing the local calculated or measured power scheme with one or more power schemes stored in the database.
